(19) United States
(12) Patent Application Publication
(10) Pub. No.: US 2025/0286243 A1
(43) Pub. Date: Sep. 11, 2025

(54) SECONDARY BATTERY INCLUDING CURRENT COLLECTOR, METHOD OF MANUFACTURING THE SECONDARY BATTERY, AND JIG FOR MANUFACTURING THE SECONDARY BATTERY

(71) Applicant: SAMSUNG SDI CO., LTD., Yongin-si (KR)

(72) Inventor: Hyun Soo LEE, Yongin-si (KR)

(21) Appl. No.: 18/796,786

(22) Filed: Aug. 7, 2024

(30) Foreign Application Priority Data
Mar. 11, 2024 (KR) 10-2024-0034148

(51) Int. Cl. H01M 50/536; H01M 10/04; H01M 50/15; H01M 50/528; H01M 50/55; H01M 50/553

(52) U.S. Cl. CPC H01M 50/536; H01M 10/0404; H01M 50/15; H01M 50/528; H01M 50/55; H01M 50/553

(57) ABSTRACT

A secondary battery having a current collector connected to a terminal, a method of manufacturing the same, and a jig to bring the current collector into close contact with the terminal are provided. The secondary battery includes a casing having an opening formed therein, an electrode assembly accommodated in the casing, a current collector electrically connected to the electrode assembly, a cap plate installed in the opening of the casing, and a terminal located on the cap plate for electrical connection to the current collector. The current collector includes a conductive boss coupled to the terminal, and a groove is formed at an end of the conductive boss, with the groove being configured to be coupled to an external jig. The external jig includes a drawbar configured to be coupled to the groove of the conductive boss such that the jig can pull the conductive boss into close contact with the terminal.

### CROSS-REFERENCE TO RELATED APPLICATION

The present application claims priority to and the benefit of Korean Patent Application No. 10-2024-0034148, filed on Mar. 11, 2024, in the Korean Intellectual Property Office, the entire disclosure of which is incorporated herein by reference.

### BACKGROUND

### 1. Field

Aspects of embodiments of the present disclosure relate to a secondary battery, and more particularly, to a secondary battery having a current collector connected to a terminal, a method of manufacturing the same, and a jig to bring the current collector into close contact with the terminal.

### 2. Description of Related Art

Unlike primary batteries that are not designed to be repeatedly charged, secondary batteries are designed to be discharged and recharged. A secondary battery includes an electrode assembly comprising a positive electrode plate, a separator, and a negative electrode plate. The secondary battery also includes a casing (or can) for accommodating the electrode assembly therein, and an external terminal that connects the electrode assembly to an external power source and load.

The electrode assembly is formed with positive and negative electrode tabs, which are connected to respective positive and negative current collectors located inside the casing. Each of the current collectors is electrically connected to an associated positive or negative terminal located outside the casing. The terminal outside the casing may be electrically connected to the current collector inside the casing by welding (e.g., laser welding).

It is important to ensure there is close contact between the current collector and the terminal to improve the quality of welding for electrically connecting the current collector inside the casing and the terminal outside the casing and the resulting product performance of the secondary battery.

The above information disclosed in this Background section is for enhancement of understanding of the background of the present disclosure, and therefore, it may contain information that does not constitute related (or prior) art.

### SUMMARY

An object of the present disclosure is to provide a current collector structurally designed to be in close contact with a terminal in a process of welding therebetween when manufacturing a secondary battery, a method for close contact therebetween, and a jig therefor.

In an embodiment, there is provided a secondary battery that includes a casing having an opening formed therein, an electrode assembly accommodated in the casing, a current collector electrically connected to the electrode assembly, a cap plate installed in the opening of the casing, and a terminal located on the cap plate for electrical connection to the current collector, wherein the current collector includes a conductive boss coupled and welded to the terminal, and the conductive boss includes a groove formed at an end of the groove, the groove being configured to be coupled to an external jig.

In another embodiment, there is provided a method of manufacturing secondary batteries, which includes providing an electrode assembly including an electrode tab, electrically connecting a current collector to the electrode tab of the electrode assembly, the current collector including a conductive boss with a groove at an end of the current collector, welding a terminal to the current collector, electrically connecting the current collector to the electrode tab of the electrode assembly, coupling a jig to the groove of the conductive boss, using the jig to pull the conductive boss into contact with the terminal, and welding a contact area of the conductive boss and the terminal.

In a further embodiment, there is provided a jig for manufacturing secondary batteries, the jig being configured to bring a terminal into contact with a groove formed at an end of a conductive boss of a current collector that is electrically connected to an electrode tab of an electrode assembly, the jig including a drawbar configured to be coupled to the groove of the conductive boss and configured to pull the conductive boss into contact with the terminal.

However, aspects and features of the present disclosure are not limited to those described above, and other aspects and features not mentioned herein will be clearly understood by a person skilled in the art from the detailed description provided below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a top perspective view of a secondary battery according to some embodiments of the present disclosure;

FIG. 2 is a cross-sectional view taken along the line I-I′ of FIG. 1;

FIG. 3 is a cross-sectional view of a secondary battery having a different internal structure from FIG. 2;

FIG. 4 illustrates a secondary battery with a side-terminal structure according to some other embodiments of the present disclosure;

FIG. 5 is an exploded perspective view illustrating a coupling relationship between current collectors and a cap assembly according to some embodiments of the present disclosure;

FIG. 6 is a cross-sectional schematic diagram for convenience of understanding of the coupling relationship between one current collector and the terminal associated therewith illustrated in FIG. 5;

FIGS. 7A and 7B illustrate a process of welding between the current collector and the terminal according to the embodiment of the present disclosure;

FIGS. 8 to 12 illustrate various examples of a shape of a drawbar and an inner wall profile of a groove;

FIG. 13 is a view of a secondary battery module in which secondary batteries are arranged according to one or more embodiments of the present disclosure;

FIG. 14 is a view of a secondary battery pack including the secondary battery module illustrated in FIG. 13; and

FIG. 15 is a conceptual view of a vehicle including the secondary battery pack illustrated in FIG. 14.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of one or more embodiments of the present disclosure and do not represent all of the aspects of the present disclosure. Accordingly, it should be understood that there may be various equivalents and modifications that can replace or modify one or more embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

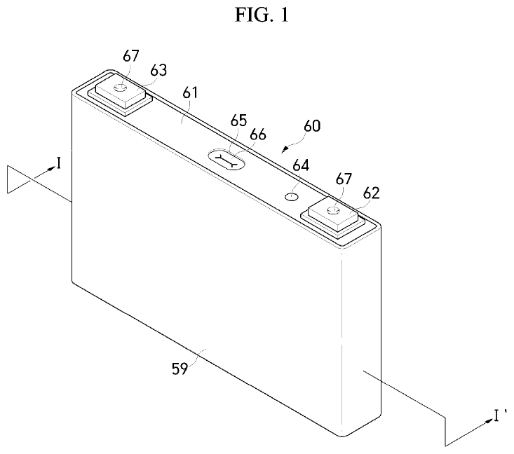

FIG. 1 is a top perspective view of a prismatic secondary battery according to some embodiments of the present disclosure.

A case 59 defines an overall appearance of the prismatic secondary battery, and the case 59 may be made of a conductive metal, such as aluminum, aluminum alloy, or nickel-plated steel. In one or more embodiments, the case 59 may provide a space for accommodating an electrode assembly therein.

A cap assembly 60 may include a cap plate 61 that covers the opening of the case 59. The case 59 and the cap plate 61 may be made of a conductive material. Here, a first terminal 62 and a second terminal 63 may be electrically connected to respective positive and negative (or negative and positive) electrodes inside the case, and the terminals 62 and 63 may be installed to protrude outwardly through the cap plate 61.

The cap plate 61 may be equipped with an electrolyte injection port 64 for installing a sealing plug (or seal pin), and a vent 66 formed with a notch 65. The vent 66 may discharge gas generated inside the secondary battery.

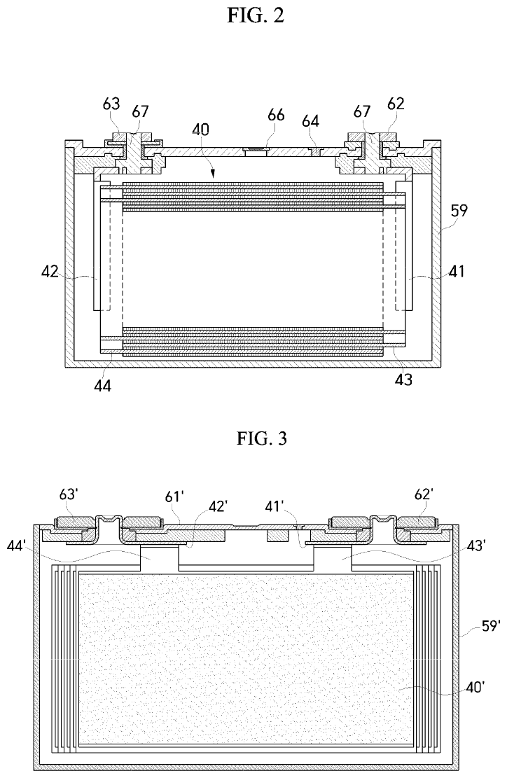

With reference to FIG. 2, the internal structure of the prismatic secondary battery and the coupling structure with the cap assembly 60 will be described.

As shown in FIG. 2, a prismatic secondary battery may include an electrode assembly 40, a first current collector 41, a first terminal 62, a second current collector 42, a second terminal 63, a case 59, and a cap assembly 60.

The electrode assembly 40 may be formed by winding or stacking a stack of a first electrode plate, a separator, and a second electrode plate, which are formed as thin plates or films. If the electrode assembly 40 is a wound stack, a winding axis may be parallel to the longitudinal direction (e.g., the y direction) of the case 59. In other embodiments, the electrode assembly 40 may be a stack type rather than a winding type, and the shape of the electrode assembly 40 is not limited in the present disclosure. In one or more embodiments, the electrode assembly 40 may be a Z-stack electrode assembly in which a positive electrode plate and a negative electrode plate are respectively inserted to both sides of a separator, which is then bent into a Z-stack. In one or more embodiments, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. In one or more embodiments, the reverse is also possible.

The first electrode plate may be formed by applying a first electrode active material, such as graphite or carbon, to a first electrode current collector formed of a metal foil, such as copper, a copper alloy, nickel, or a nickel alloy. The first electrode plate may include a first electrode tab 43 (e.g., a first uncoated portion) that is a region to which the first electrode active material is not applied. The first electrode tab 43 may act as a current flow path between the first electrode plate and the first current collector 41. In some embodiments, when the first electrode plate is manufactured, the first electrode tab 43 may be formed by being cut so as to protrude to one side of the electrode assembly 40, or the first electrode tab 43 may protrude to one side of the electrode assembly 40 more than (e.g., farther than, or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 44 (e.g., a second uncoated portion) that is a region to which the second electrode active material is not applied. The second electrode tab 44 may act as a current flow path between the second electrode plate and the second current collector 42. In some embodiments, the second electrode tab 44 may be formed by being cut so as to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some embodiments, the first electrode tab 43 may be located on the right side of the electrode assembly 40, and the second electrode tab 44 may be located on the left side of the electrode assembly 40. In other embodiments, the first electrode tab 43 and the second electrode tab 44 may be located on one side of the electrode assembly 40 in the same direction. Here, for convenience of description, the left and right sides are defined according to the secondary battery as oriented in FIG. 2A, and the positions thereof may change if the secondary battery is rotated left and right or up and down.

The separator reduces or prevents the likelihood of a short circuit between the first electrode and the second electrode while allowing movement of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate may be positioned at both ends (e.g., opposite ends) of the electrode assembly 40. In some embodiments, the electrode assembly 40 may be accommodated in the case 10 along with an electrolyte. In one or more embodiments of the electrode assembly 40, the first current collector 41, and the second current collector 42 may be respectively welded and connected to the first electrode tab 43 of the first electrode plate and the second electrode tab 44 of the second electrode plate exposed on both sides of the electrode assembly so as to position the tabs 43 and 44.

As mentioned above, in some embodiments the first electrode tab 43 and the second electrode tab 44 are located at the top of the electrode assembly 40. Accordingly, in these embodiments, the first and second current collectors 41 and 42 are located at the top of the electrode assembly 40.

The first current collector 41 and the second current collector 42 may be respectively connected to the first terminal 62 and the second terminal 63 described in FIG. 1 through connection members 67. In some embodiments, the connection members 67 may each have an outer peripheral surface that is threaded, and the connection members 67 may be fastened to the first terminal 62 and the second terminal 63 (e.g., by screws, by riveting, or by welding).

The secondary battery illustrated in FIG. 2 has a structure in which the electrode assembly 40 is arranged such that the first electrode tab 43 and the second electrode tab 44 thereof are located at opposite sides of the secondary battery, which is called a side-tab structure. In addition, this structure falls under the category of top-terminal structures as the first terminal 62 and the second terminal 63 are located at the top of the casing 51.

FIG. 3 is a cross-sectional view of a secondary battery having a different internal structure from FIG. 2. FIG. 3 illustrates a secondary battery having a top-tab structure in which an electrode assembly 40′ is arranged such that the first electrode tab 43′ and the second electrode tab 44′ are located at the top of the secondary battery, unlike that in FIG. 2. The secondary battery in FIG. 3 also has a top-terminal structure in which a first terminal 62′ and a second terminal 63′ are located at the top of the secondary battery.

In the secondary battery with the top-tab and top-terminal structure illustrated in FIG. 3, the first electrode tab 43′ and the second electrode tab 44′ of the electrode assembly 40′ are located at the top of a casing 59′ and respectively connected to a first current collector 41′ and a second current collector 42′, and the first terminal 62′ and the second terminal 63′ connected to the respective current collectors 41′ and 42′ are installed outside of a cap plate 61′. The other parts of the above secondary battery is similar to that of the secondary battery with the side-tab structure illustrated in FIG. 2.

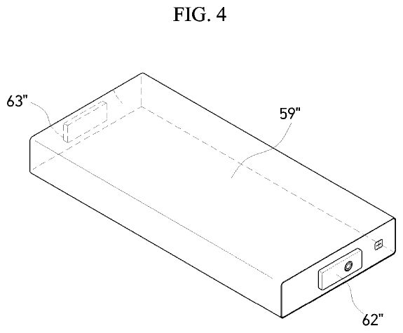

FIG. 4 illustrates a secondary battery with a side-terminal structure.

FIG. 4 illustrates a secondary battery in which a first terminal 62″ and a second terminal 63″ are located on opposite sides of a casing 59″, unlike the secondary batteries in FIGS. 1 to 3. Since the terminals 62″ and 63″ are located on opposite sides of the casing 59″, the arrangement of the electrode assembly, the electrode tabs, and the current collector in the secondary battery is similar to that in the secondary battery of FIG. 2.

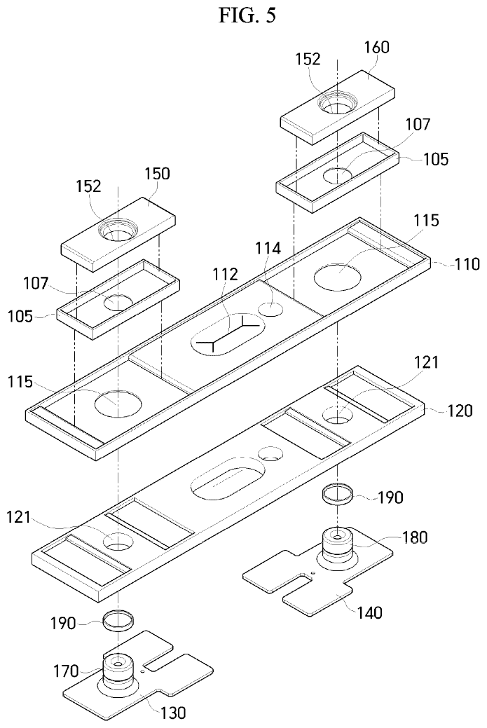

FIG. 5 is an exploded perspective view illustrating a coupling relationship between current collectors and a cap assembly according to an embodiment of the present disclosure.

Current collectors 130 and 140 located beneath a cap plate 110 may be connected to the respective positive and negative electrode tabs 43 and 44 (see FIG. 2) or 43′ and 44′ (see FIG. 3) of the electrode assembly 40 or 40′ (see FIG. 2 or 3) in the casing and to respective terminals 150 and 160 located above the cap plate 110. The cap plate 110 may have a vent 112 and an electrolyte injection port 114 formed therein.

A bottom insulator 120 may be located at the bottom of the cap plate 110, and a first current collector 130 and a second current collector 140 may be located beneath the bottom insulator 120. A first terminal 150 and a second terminal 160 may be located above the cap plate 110. The terminals 150 and 160 may be electrically connected to the respective first and second current collectors 130 and 140.

In FIG. 5, the first current collector 130 and the second current collector 140 are illustrated as being used in the top-tab structure in which the electrode tabs 43′ and 44′ are located at the top of the electrode assembly 40′ as previously mentioned with reference to FIG. 3. However, the first current collector 130 and the second current collector 140 are not limited to being used in the above top-tab structure in the present disclosure. For example, they may also be applied to the battery with the side-tab structure illustrated in FIG. 2.

In the embodiment of the present disclosure for electrical connection between the first terminal 150 and the second terminal 160 located above the cap plate 110 and the first current collector 130 and the second current collector 140, conductive bosses 170 and 180 are provided on the first current collector 130 and the second current collector 140, respectively. The conductive bosses 170 and 180 may allow the first terminal 150 and the second terminal 160 to be electrically connected to the first current collector 130 and the second current collector 140, respectively.

In FIG. 5, an insulator(s) 105 may be interposed between the first terminal 150 and/or the second terminal 160 and the surface of the cap plate 110 located beneath the terminals 150 and 160. This insulator 105 may, for example, prevent shorting with the positive terminal when the casing has negative polarity (and vice versa). In addition, each of the conductive bosses 170 and 180 on the first and second current collectors 130 and 140 may be equipped with a seal gasket 190 to seal the battery casing. The seal gaskets 190 may seal an electrolyte that is contained in the casing.

The components of the cap assembly, for example, the bottom insulator 120, the cap plate 110, the insulators 105, the first terminal 150, and the second terminal 160 may have through-holes 121, 115, and 107 formed allow the conductive bosses 170 and 180 on the lowest first and second current collectors 130 and 140 to pass therethrough. The conductive bosses 170 and 180 that pass through these through-holes may be coupled to the through-holes 152 of the uppermost first and second terminals 150 and 160 for electrical connection.

Since the first and second current collectors 130 and 140 have the same structure and shape and the first and second terminals 150 and 160 have the same structure and shape, for simplicity of description, only one current collector 130 and one terminal 150 will be described below.

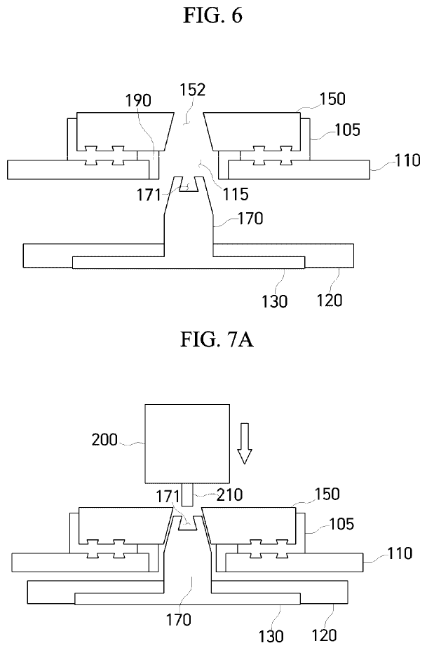

FIG. 6 is a cross-sectional schematic diagram for understanding of the coupling relationship between one current collector and the terminal associated therewith illustrated in FIG. 5 and illustrates a state before the two components are coupled to each other. FIG. 6 is a simplified diagram of the configuration of FIG. 5. The structure in FIG. 6 is applicable to both the top-terminal structures illustrated in FIGS. 2 and 3 and the side-terminal structure illustrated in FIG. 4.

In FIG. 6, the current collector 130 located beneath (i.e., inside the casing of the secondary battery) the cap plate 110 may be connected to the electrode tab of the electrode assembly in the casing. The protrusion (i.e., the conductive boss 170) of the current collector 130 may be connected to the terminal 150 located above (i.e., outside the casing of the secondary battery) the cap plate 110. In other words, the conductive boss 170 may be formed on the current collector 130 and may be coupled and welded to the through-hole 152 of the terminal 150, located above the cap plate 110, with the boss 170 extending through the through-hole 115 of the cap plate 110.

The bottom insulator 120 may be located between the current collector 130 and the cap plate 110 for electrical insulation therebetween. In addition, the seal gasket 190 may be provided between the conductive boss 170 on the current collector 130 and the cap plate 110 for electrical insulation and sealing therebetween.

As such, the current collector 130 inside the casing and the terminal 150 outside the casing may be electrically connected by contact through the conductive boss 170 and by welding (e.g., laser welding). In order to prevent deterioration of the physical rigidity and electrical performance of the weld, it is important to ensure the close contact between the through-hole 152 of the terminal 150 and the conductive boss 170 before welding. Therefore, welding may be carried out with the terminal 150 and the conductive boss 170 in firm, close contact with each other.

For this purpose, the welding may be carried out in a state in which a groove 171 is formed at the end of the conductive boss 170 on the current collector 130 and the current collector 130 is pulled up by hooking a traction means installed on a jig located outside the casing to the groove 171 to bring the conductive boss 170 into close contact with the through-hole 152 of the terminal 150.

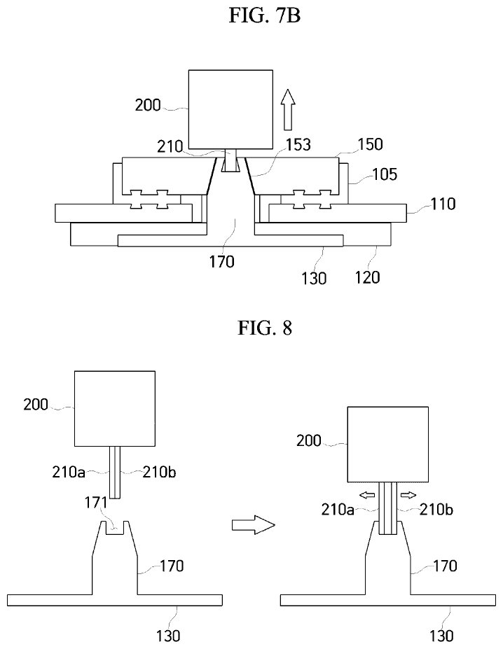

FIGS. 7A and 7B illustrate a process of welding between the current collector and the terminal according to the embodiment of the present disclosure.

FIG. 7A illustrates a state before welding where the conductive boss 170 on the current collector 130 is located beneath the cap plate 110 on which the terminal 150 is placed. In FIG. 7A, a jig 200 with a drawbar 210 protruding downward may move down to insert the drawbar 210 through the through-hole 152 (see FIG. 6) of the terminal 150 into the groove 171 formed at the end of the conductive boss 170. The drawbar 210 may thereby be coupled to the groove 171 as described below.

FIG. 7B illustrates a state in which the jig 200 moves up to pull the conductive boss 170 upward by the drawbar 210. Since the drawbar 210 is coupled to the groove 171 at the end of the conductive boss 170 in FIG. 7A, the conductive boss 170 may be pulled up by the rise of the jig 200 to come into close contact with the inner surface of the terminal that forms the through-hole 152. In this way, welding may be performed at a contact area 153 where the terminal 150 is in tight contact with the conductive boss 170.

Here, the conductive boss 170 may be a rivet terminal. In this case, riveting and welding may be performed together by bringing the conductive boss 170 into close contact with the through-hole 152 of the terminal 150. The order of operation of riveting and welding is not limited.

After welding (and/or riveting), the drawbar 210 of the jig 200 is separated from the groove 171 of the conductive boss 170 as described below.

Hereinafter, various examples of the coupling method of the drawbar 210 of the jig 200 to the groove 171 at the end of the conductive boss 170 will be described.

FIG. 8 illustrates an example of the shape of the drawbar 210 and the inner wall profile of the groove 171, wherein the drawbar of the jig 200 includes a first drawbar 210a and a second drawbar 210b. The groove 171 of the conductive boss 170 may be formed to have a flat vertical inner wall.

The first drawbar 210a and the second drawbar 210b may be close to each other to have an overall width smaller than or equal to the width of the groove 171 before they are coupled to the groove 171. As such, the first drawbar 210a and the second drawbar 210b may be inserted into the groove 171.

After the jig 200 moves down to insert the first drawbar 210a and the second drawbar 210b into the groove 171, the first drawbar 210a and the second drawbar 210b are moved outwardly away from each other by a mechanism provided in the jig 200. This enables the first drawbar 210a and the second drawbar 210b to come into contact with opposite sides of the inner wall surface of the groove 171. The drawbars 210a and 210b are thereby coupled to the groove 171 while pushing both sides of the inner wall surface. In this state, lifting the jig 200 allows the conductive boss 170 and the current collector 130 to be pulled up by the coupling of the groove 171 to the first drawbar 210a and the second drawbar 210b.

Examples of the mechanism that causes the first drawbar 210a and the second drawbar 210b to move away from each other in opposite directions may include a mechanism similar to scissors in which two arms open from a center point or a mechanism for moving the first drawbar 210a and the second drawbar 210b outward in parallel.

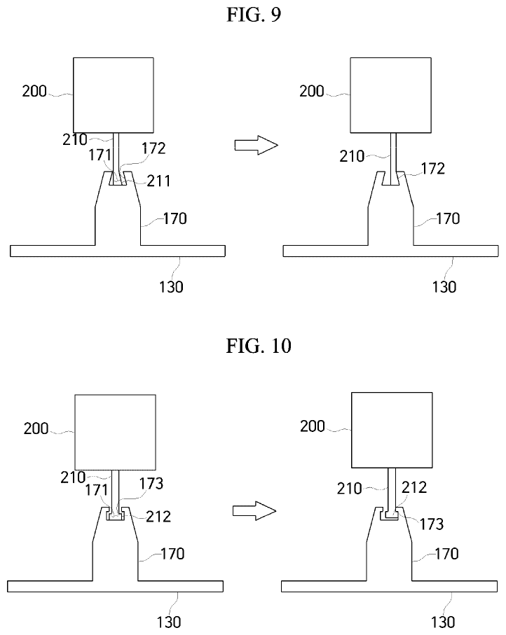

FIG. 9 illustrates another example of the shape of the drawbar 210 and the inner wall profile of the groove 171. In this case, an inclined part 211 is formed at the distal end of the drawbar 210 of the jig 200 and a reverse inclined part 172 is correspondingly formed on the inner wall of the groove 171 of the conductive boss 170.

After the jig 200 with this type of drawbar 210 moves downward such that the drawbar 210 is inserted into the groove 171, the drawbar 210 is moved to one side to bring the inclined part 211 into contact with the reverse inclined part 172 of the groove 171 by the mechanism provided in the jig 200. In this state, lifting the jig 200 allows the reverse inclined part 172 of the groove 171 to be pulled up by the inclined part 211 of the drawbar 210.

Examples of the mechanism for moving the drawbar 210 inserted into the groove 171 to one side may include a mechanism for rotating the drawbar 210 around the pivot axis in the jig 200 or a mechanism for moving the drawbar 210 in parallel.

FIG. 10 illustrates still another example of the shape of the drawbar 210 and the inner wall profile of the groove 171. In this case, a square latch 212 is formed at the distal end of the drawbar 210 of the jig 200 and a square jaw 173 is correspondingly formed on the inner wall of the groove 171 of the conductive boss 170.

After the jig 200 with this type of drawbar 210 moves downward to insert the drawbar 210 into the groove 171, the drawbar 210 is moved to one side to latch the square latch 212 to the square jaw 173 of the groove 171 by the mechanism provided in the jig 200. In this state, lifting the jig 200 may allow the latch 212 of the drawbar 210 to pull the jaw 173 of the groove 171 to raise the current collector 130.

Examples of the mechanism for moving the drawbar 210 inserted into the groove 171 to one side may include a mechanism for rotating the drawbar 210 around the pivot axis in the jig 200 or a mechanism for moving the drawbar 210 in parallel.

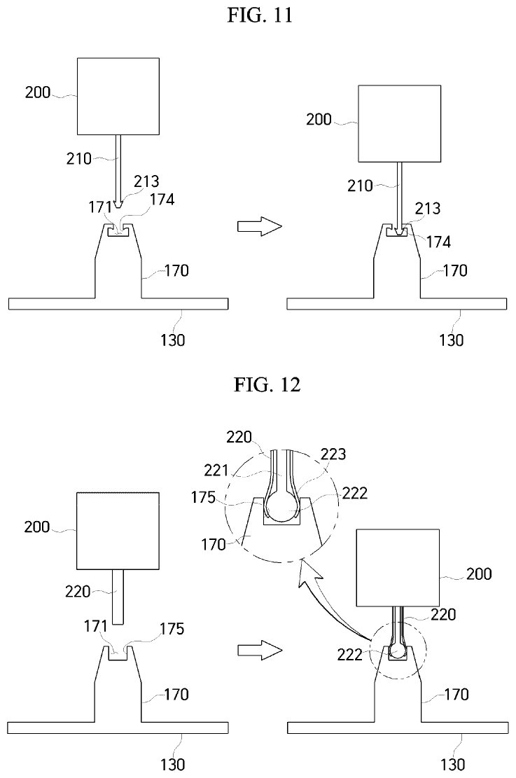

FIG. 11 illustrates yet another example of the shape of the drawbar 210 and the inner wall profile of the groove 171. In this case, an arrowhead-shaped hook 213 is formed at the distal end of the drawbar 210 of the jig 200 and a locking groove 174 is correspondingly formed on the inner wall of the groove 171 of the conductive boss 170.

After the jig 200 with this type of drawbar 210 moves downward to insert the drawbar 210 into the groove 171, the drawbar 210 is moved to one side to latch the hook 213 to the locking groove 174 of the groove 171 by the mechanism provided in the jig 200. In this state, lifting the jig 200 may allow the hook 213 of the drawbar 210 to pull the locking groove 174 of the groove 171 to raise the current collector 130.

Examples of the mechanism for moving the drawbar 210 inserted into the groove 171 to one side may include a mechanism for rotating the drawbar 210 around the pivot axis in the jig 200 or a mechanism for moving the drawbar 210 in parallel.

FIG. 12 illustrates a further example of the shape of the drawbar 210 and the inner wall profile of the groove 171.

The groove 171 of the conductive boss 170 may be formed to have a flat vertical inner wall 175. The drawbar 220 of the jig 200 may be a flexible tube with a diameter that is insertable into the groove 171.

When the jig 200 moves downward, the drawbar 220 in the form of the flexible tube is inserted into the groove 171. A hard rod 221 then descends through the flexible tube inside the drawbar 220. At the end of this rod 221 is a bead 222 with a diameter that is larger than the diameter of the tube and is smaller than the inner diameter of the groove 171. As the bead 222 passes through the tube, the tube expands to form an expanded diameter part 223, thereby bringing the tube into close contact with the vertical inner wall 175 of the groove 171. In this way, when the jig 200 is lifted in the state in which the expanded diameter part 223 of the tube (drawbar 210) is in close contact with the inner wall 175 of the groove 171, the conductive boss 170 is pulled upward by the draw bar 210.

In this example, the inner surface of the groove 171 of the conductive boss 170 is machined into a vertical wall, which can increase productivity and reduce costs.

A method of manufacturing a secondary battery including the above-mentioned current collector will be described with reference to FIGS. 7A and 7B.

First, the current collector 130 is connected to the electrode tab 41 or 42 (see FIG. 2) or 41′ or 42′ (see FIG. 3) of the manufactured electrode assembly 40 (see FIG. 2) or 40′ (see FIG. 3) and embedded in the casing, and the cap plate 110 covers the current collector 130. Here, the groove 171 is formed at the end of the current collector 130.

When the terminal 150 is placed on the cap plate 110, the conductive boss 170 on the current collector 130 is located beneath the cap plate 110 as illustrated in FIG. 7A.

The jig 200 with the drawbar 210 protruding downward moves downward so that the drawbar 210 descends through the through-hole 152 of the terminal 150 and is inserted into the groove 171 at the end of the conductive boss 170.

As illustrated in FIG. 7B, raising the jig 200 allows the drawbar 210 to pull the groove 171 upward to raise the conductive boss 170. Accordingly, the conductive boss 170 comes into close contact with the inner surface of the terminal that forms the through-hole 152. Welding may then be performed in the contact area 153.

After the welding is completed, the drawbar 210 of the jig 200 is separated from the groove 171.

Hereinafter, materials that may be used for manufacturing a secondary battery according to the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof are a lithium nickel-based oxide, a lithium cobalt-based oxide, a lithium manganese-based oxide, a lithium iron phosphate-based compound, a cobalt-free nickel-manganese-based oxide, or a combination thereof.

As further examples, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); or LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material may be in a range of about 90 wt % to about 99.5 wt % on the basis of 100 wt % of the positive electrode active material layer. The content of the binder and the conductive material may be in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of silicon particles and amorphous carbon coated on the surfaces of the silicon particles.

The silicon-carbon composite may further include crystalline carbon. For example, the silicon-carbon composite may include a core including crystalline carbon and silicon particles and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

The negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. If an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt. The non-aqueous organic solvent acts as a medium through which ions involved in the electrochemical reaction of the battery can move. The non-aqueous organic solvent may be a carbonate-based, an ester-based, an ether-based, a ketone-based, an alcohol-based solvent, an aprotic solvent, and may be used alone or in combination of two or more. If a carbonate-based solvent is used, a mixture of cyclic carbonate and chain carbonate may be used.

Depending on the type of lithium secondary battery, a separator may be provided between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto. The organic material and the inorganic material may be mixed in one coating layer or may be in the form of a coating layer containing an organic material and a coating layer containing an inorganic material that are laminated on each other.

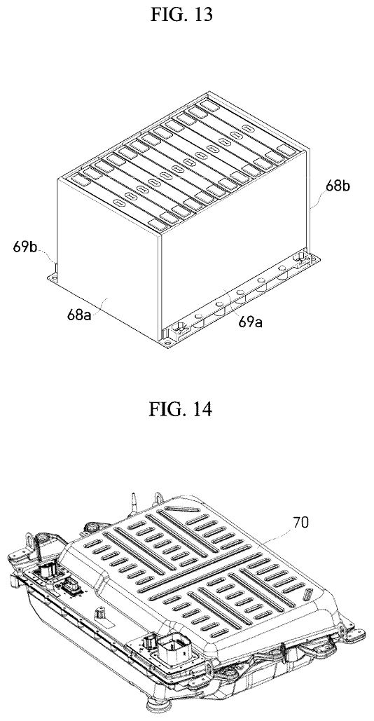

FIG. 13 is a view of a secondary battery module in which prismatic secondary batteries are arranged according to one or more embodiments of the present disclosure. With the increased need for secondary battery capacity for electric vehicles or the like, a secondary battery module may be manufactured by arranging and connecting a plurality of secondary battery cells transversely and/or longitudinally. The plurality of secondary batteries may be arranged in a space defined by a pair of facing/opposite end plates 68a and 68b and a pair of facing/opposite side plates 69a and 69b. The secondary batteries may be designed appropriately in both arrangement (direction) and number to obtain desired voltage and current specifications.

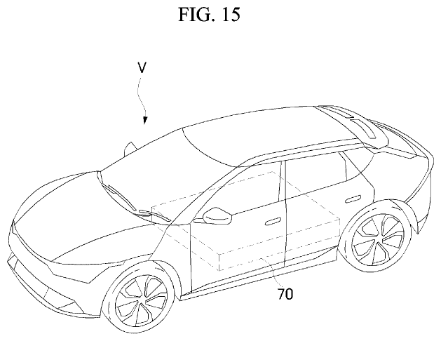

FIG. 14 is a view schematically showing the configuration of a battery pack 70 according to one or more embodiments of the present disclosure. Referring to FIG. 14, the battery pack 70 includes an assembly to which individual batteries are electrically connected and a pack housing accommodating the same. In the drawings, for convenience of illustration, some components, including a bus bar, a cooling unit, external terminals for electrically connecting batteries, etc., are omitted.

The battery pack may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle, but is not limited thereto.

FIG. 15 is a view showing a vehicle according to one or more embodiments of the present disclosure including the battery pack 70 shown in FIG. 14. Referring to FIG. 15, the vehicle V may include a battery pack 70 according to one or more embodiments of the present disclosure. The vehicle V may operate by (e.g., may be powered by) receiving power from the battery pack 70.

As is apparent from the above description, according to the present disclosure it is possible to perform welding while ensuring close contact between the current collector and the terminal by pulling on the current collector, which is inside the casing, from the outside. The current collector is thereby brought into close contact with the terminal when manufacturing a secondary battery. This can result in improved quality of welding, extended product performance, and longer lifespan for the secondary battery.

Although the present disclosure has been described above with respect to embodiments thereof, the present disclosure is not limited thereto. Various modifications and variations can be made thereto by those skilled in the art within the spirit of the present disclosure and the equivalent scope of the appended claims, with functional equivalents thereof to be included therein.

What is claimed is:

1. A secondary battery comprising:
a casing having an opening formed therein;
an electrode assembly accommodated in the casing;
a current collector electrically connected to the electrode assembly;
a cap plate installed in the opening of the casing; and
a terminal located on the cap plate for electrical connection to the current collector,
wherein the current collector comprises a conductive boss coupled and welded to the terminal, and
wherein the conductive boss comprises a groove formed at an end of the conductive boss, the groove being configured to be coupled to an external jig.

2. The secondary battery according to claim 1, wherein the cap plate comprises a through-hole, with the conductive boss extending through the through-hole of the cap plate.

3. The secondary battery according to claim 1, wherein the terminal comprises a through-hole, with the conductive boss being in contact with a surface of the through-hole, and with the conductive boss being configured to be coupled to a drawbar of the external jig when the conductive boss extends through the through-hole of the terminal.

4. The secondary battery according to claim 1, wherein the conductive boss is a rivet terminal.

5. The secondary battery according to claim 1, wherein the groove of the conductive boss comprises a flat vertical inner wall.

6. The secondary battery according to claim 1, wherein the groove of the conductive boss comprises a square jaw configured to be coupled to a square latch.

7. The secondary battery according to claim 1, wherein the groove of the conductive boss comprises a locking groove configured to be coupled to a hook.

8. A method of manufacturing secondary batteries, the method comprising:
1) providing an electrode assembly comprising an electrode tab;
2) electrically connecting a current collector to the electrode tab of the electrode assembly, the current collector comprising a conductive boss with a groove at an end of the current collector;
3) welding a terminal to the current collector;
4) electrically connecting the current collector to the electrode tab of the electrode assembly;
5) coupling a jig to the groove of the conductive boss,
6) using the jig to pull the conductive boss into contact with the terminal, and
7) welding a contact area of the conductive boss and the terminal.

9. The method according to claim 8, wherein the jig comprises a first drawbar and a second drawbar that are insertable into the groove, and
wherein the coupling of the jig to the groove of the conductive boss comprises inserting the first drawbar and the second drawbar of the jig into the groove and then moving the first drawbar and the second drawbar away from each other to couple the first drawbar and the second drawbar to the groove.

10. The method according to claim 8, wherein the jig comprises a drawbar including an inclined part formed at a distal end of the drawbar, and a reverse inclined part corresponding to the inclined part of the drawbar is formed in the groove of the conductive boss, and
wherein coupling the jig to the groove of the conductive boss comprises coupling the inclined part of the drawbar to the reverse inclined part of the groove.

11. The method according to claim 8, wherein the jig comprises a drawbar including a square latch formed at a distal end of the drawbar, and a square jaw corresponding to the square latch of the drawbar is formed in the groove of the conductive boss, and
wherein coupling the jig to the groove of the conductive boss comprises coupling the square latch of the drawbar to the square jaw of the groove.

12. The method according to claim 8, wherein:
the jig comprises a drawbar including a hook formed at a distal end of the drawbar, and a locking groove corresponding to the hook of the drawbar is formed in the groove of the conductive boss, and
wherein coupling the jig to the groove of the conductive boss comprises coupling the hook of the drawbar to the locking groove of the groove.

13. The method according to claim 8, wherein the jig comprises a drawbar including a flexible tube, with a rod with a bead attached passing through the inside of the flexible tube, and
wherein coupling the jig to the groove of the conductive boss comprises expanding a diameter of the flexible tube as the rod with the bead attached thereto passes through the flexible tube and bringing the flexible tube into close contact with an inner wall of the groove.

14. A jig for manufacturing secondary batteries, the jig being configured to bring a terminal into contact with a groove formed at an end of a conductive boss of a current collector that is electrically connected to an electrode tab of an electrode assembly, the jig comprising:
a drawbar configured to be coupled to the groove of the conductive boss and configured to pull the conductive boss into contact with the terminal.

15. The jig according to claim 14, wherein the drawbar comprises a first drawbar and a second drawbar configured to be inserted into the groove of the conductive boss and move away from each other for coupling the jig to the groove.

16. The jig according to claim 14, wherein the drawbar comprises an inclined part formed at a distal end of the drawbar, the inclined part being configured to be coupled to a reverse inclined part formed in the groove.

17. The jig according to claim 14, wherein the drawbar comprises a square latch formed at a distal end of the drawbar, the square latch being configured to be coupled to a square jaw formed in the groove.

18. The jig according to claim 14, wherein the drawbar comprises a hook formed at a distal end of the drawbar, the hook being configured to be coupled to a locking groove formed in the groove.

19. The jig according to claim 14, wherein the drawbar include a flexible tube and a rod with a bead configured to pass through an inside of the flexible tube, and the flexible tube is configured to contact an inner wall of the groove for coupling the jig to the groove.
